(19) United States
(12) Patent Application Publication
(10) Pub. No.: US 2019/0140851 A1
(43) Pub. Date: May 9, 2019

(54) SECURE LOGIC SYSTEM WITH PHYSICALLY UNCLONABLE FUNCTION

(71) Applicant: iMQ Technology Inc., HSINCHU CITY (TW)

(72) Inventors: TANGKWAI MA, Plano, TX (US); YOLANDA HINNGONG LEI, Sachse, TX (US); Ren-Cheng Huang, Hsinchu City (TW)

(21) Appl. No.: 15/928,101

(22) Filed: Mar. 22, 2018

Related U.S. Application Data
(60) Provisional application No. 62/583,499, filed on Nov. 9, 2017.

(51) Int. Cl. H04L 9/32; G06F 21/72

(52) U.S. Cl. CPC H04L 9/3278; G06F 21/72

(57) ABSTRACT

A secure logic system includes a physically unclonable function, a physically unclonable function configuration register, and an encryption circuit. The physically unclonable function establishes an encryption string according to at least partial random physical characteristics of the physically unclonable function. The physically unclonable function configuration register is coupled to the physically unclonable function, and load the encryption string from the physically unclonable function. The encryption circuit is coupled to the physically unclonable function configuration register, and manipulates a system string with the encryption string to generate encrypted data.

### CROSS REFERENCE TO RELATED APPLICATIONS

This non-provisional application claims priority of U.S. provisional application 62/583,499, filed on Nov. 9, 2017, included herein by reference in its entirety.

### BACKGROUND OF THE INVENTION

1. Field of the Invention

This invention relates to a secure logic system, and more particularly, a secure logic system with a physically unclonable function.

2. Description of the Prior Art

As reverse engineering methods of physical intellectual property (IP) and devices become automatable, physical and side-channel attacks have become much more affordable and powerful, raising the issues of exposure of sensitive information. To prevent valuable technologies from being copied by competitors and to prevent the devices from being accessed by unauthorized people, manufactures and property owners usually spend a significant amount of money and time to develop countermeasures to safeguard against adversaries.

To protect the system from physical attacks and to raise the barrier for reverse engineering, the integrated circuit physical unclonable function (PUF) may be applied due to its intrinsic characteristics.

The integrated circuit physical unclonable function can establish a bit string pattern due to uncontrollable random physical characteristics in a manufacturing process. The process variations can come from very small changes in process control, material contents, and/or environmental drift. These natural variations are not only unavoidable during manufacturing but are also very hard to reproduce, making duplication of the same string pattern very difficult.

Normally, a particular string pattern is formed when the circuit component is settled into a stable state after power up. The formation of the string pattern is partially dependent on the physical microstructure of the particular components. Since the forming conditions are varied with time and environment, the dependencies on forming conditions can create enough uniqueness for individual components. However, although the PUF may offer root of trust to the system, it still remains an issue on how to adopt the PUF into the system effectively and economically to secure information.

### SUMMARY OF THE INVENTION

One embodiment of the present invention discloses a secure logic system. The secure logic system includes a physically unclonable function (PUF), a physically unclonable function configuration register, and an encryption circuit.

The physically unclonable function is for establishing an encryption string according to at least partial random physical characteristics of the physically unclonable function. The physically unclonable function configuration register is coupled to the physically unclonable function, and for loading the encryption string from the physically unclonable function. The encryption circuit is coupled to the physically unclonable function configuration register, and is for manipulating a system string with the encryption string to generate encrypted data.

Another embodiment of the present invention discloses a method for operating a secure logic system. The secure logic system includes a physically unclonable function (PUF), a physically unclonable function configuration register, and an encryption circuit.

The method includes the physically unclonable function establishing an encryption string according to at least partial random physical characteristics of the physically unclonable function, the physically unclonable function configuration register loading the encryption string from the physically unclonable function, and the encryption circuit manipulating a system string with the encryption string to generate encrypted data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a secure logic system according to one embodiment of the present invention.

FIG. 2 shows a secure logic system according to another embodiment of the present invention.

FIG. 3 shows a secure logic system according to another embodiment of the present invention.

FIG. 4 shows a secure logic system according to another embodiment of the present invention.

FIG. 5 shows a flow chart of a method for operating the secure logic system in FIG. 1.

FIG. 6 shows a flow chart of a method for operating the secure logic system in FIG. 2.

### DETAILED DESCRIPTION

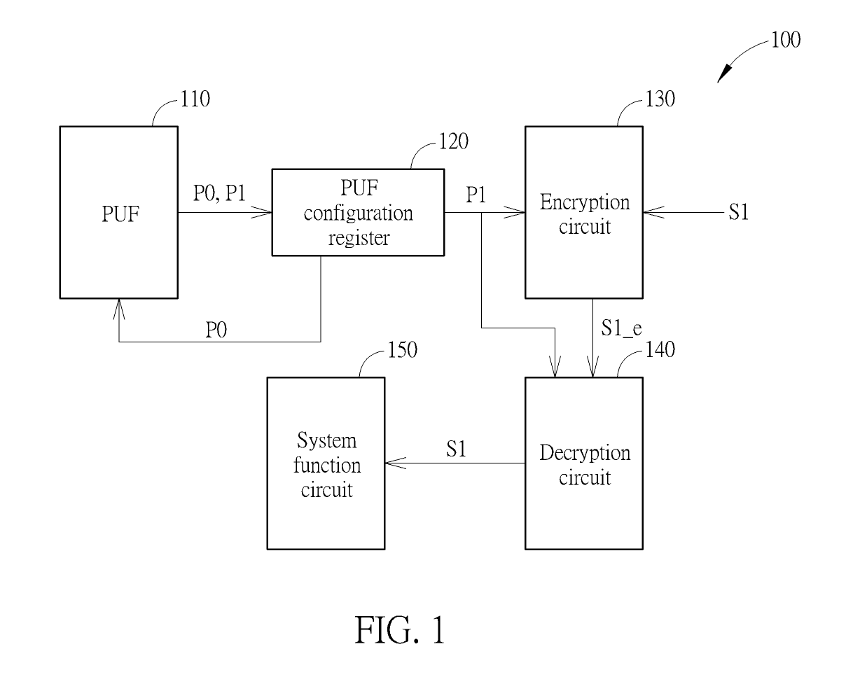

FIG. 1 shows a secure logic system 100 according to one embodiment of the present invention. The secure logic system 100 includes a physically unclonable function (PUF) 110, a physically unclonable function configuration register 120, and an encryption circuit 130.

The physically unclonable function 110 can establish an encryption string P1 according to at least partial random physical characteristics of the physically unclonable function 110. The unique encryption string P1 can offer the deep-root security as a result of silicon manufacturing variations. For example, the secure logic system 100 can achieve confidentiality by entangling seemly regular and easily recognizable logic structures with the unclonable encryption string P1 established by the physical unclonable function 110, making at least one of the control path and the data pattern unique to each individual device.

The physically unclonable function configuration register 120 is coupled to the physically unclonable function 110, and can load the encryption string P1 from the physically unclonable function 110. This configuration register can be designed with instant wipe capability so its content will be completely removed or randomized in a controllable fashion.

In some embodiments of the present invention, the physically unclonable function 110 may include more than one PUF unit, that is, the physically unclonable function 110 may establish a plurality of unique strings. In this case, the address of the encryption string P0 and P1 can be determined by firmware at the early phase of device initialization or a default setting during the system power-on reset.

In some embodiments, the initial system condition used to load the encryption string P0 and P1 may be stored in a safe environment or a one-time programming circuit, such as an anti-fuse circuit. In this case, if the PUF configuration register 120 is reset due to some security threats, then the encryption string P0 and P1 can still be regenerated by the PUF 110 according to the stored information, allowing the system to be restored.

The encryption circuit 130 is coupled to the physically unclonable function configuration register 120, and the encryption circuit 130 can manipulate a system string S1 with the encryption string P1 to generate encrypted data S1_e. The system string S1 can be, for example but not limited to, a memory address, memory data, or an instruction. That is, the encryption circuit 130 may use Boolean equations or other algorithms to mix the encryption string P1 with the system string S1 to be protected.

For example, the encryption circuit 130 may perform an Excess-N binary coding scheme to manipulate the system string S1 by using the encryption string P1 as a seed to select at least one inverting bit of the system string S1. That is, the unique encryption sting P1 can be used to determine which specific permutation is applied to the system string S1.

For instance, if the encryption string P1 has a value of 1, the encryption circuit 130 would invert the value of bit 0 as Excess-1.

If the encryption string P1 has a value of 2, the encryption circuit 130 would invert the value of bit 1 as Excess-2. If the encryption string P1 has a value of 4, the encryption circuit 130 would invert the value of bit 2 as Excess-4. Also, if the encryption string P1 has a value of 3, the encryption circuit 130 would invert the value of bit 0 and bit 1 as Excess-3.

With the Excess-N binary coding scheme, the system string S1 can be easily manipulated with the encryption string P1 to create unpredictable permutations. In the case of the system string S1 being a memory address, the unpredictable permutation can further expand the virtual addressing space of a storage unit beyond its physical range, adding layers of protection to the logical configuration of storage units.

Furthermore, in some embodiments of the present invention, since most of the storage addressing schemes are multi-dimensional, the protection can be further enhanced by using un-correlative encryption strings loaded from different PUF units in the PUF 110 for segment, row, and column addressing to further diffuse the addressing information.

Also, the Excess-N binary coding scheme can be easily decoded with the encryption string P1 when the system string S1 is required for system operations. In FIG. 1, the secure logic system 100 further includes a decryption circuit 140, and a system function circuit 150.

The decryption circuit 140 can be coupled to the PUF configuration register 120, and can decrypt the encrypted data S1_e to restore the system string S1 according to the encryption string P1 retreated from the PUF configuration register 120. For example, the decryption circuit 140 can invert the inverted bit(s) of the encrypted data S1_e again according to the encryption string P1.

After the system string S1 is restored by the decryption circuit 140, the system function circuit 150 coupled to the decryption circuit 140 would be able to perform operations according to the system string S1. For example, if the system string S1 is a memory address, the system function circuit 150 may perform a read operation or a write operation to the storage space corresponding to the address indicated by the system string S1.

In some embodiments, the decryption circuit 140 can be disposed on a signal path between the encryption circuit 130 and the system function circuit 150, and the decryption circuit 140 can decrypt the encrypted data S1_e to restore the system string S1 right at the system function circuit 150, preventing the restored system string S1 from being retrieved by the side-channel attacks and reverse engineering.

Also, in some embodiments, if the system string S1 is an address and the mutation caused by the encryption string P1 is mainly for reducing the predictability of the access to the memory system, then the encrypted data S1_e may be used as a physical address for accessing the data stored in the memory system without being decrypted. In this case, the decryption circuit 140 can be optional, that is, the encrypted data S1_e can be used directly by the memory system or the system function circuit 150, without decrypted by the decryption circuit 140, creating an unique memory mapping for each individual device.

In addition, to further randomize the access of the PUF 110, in FIG. 1, the encryption string P0 obtained from the PUF 110 can be used to encrypt the address of the PUF 110. That is, when the system requests for an unpredictable string from the PUF 110, the default address may be manipulated by the similar method mentioned above with the encryption string P0. For example, the address for loading the encryption strings may be derived by entangling the encryption string P0 to a default address. Consequently, the access to the PUF 110 can be protected, and the security of the system can be further enhanced.

Although the encryption circuit 130 may perform the Excess-N binary coding scheme to introduce the encryption string P1 into the system, this is not to limit the present invention. For example, in some other embodiments, if an arbitrary logical function can be realized by using exclusive paths, such as paths with NAND gates and NOR gates, the encryption circuit 130 may simply activate one of the two possible paths for particular operation according to the encryption string S1_e to further complicate the internal process logic.

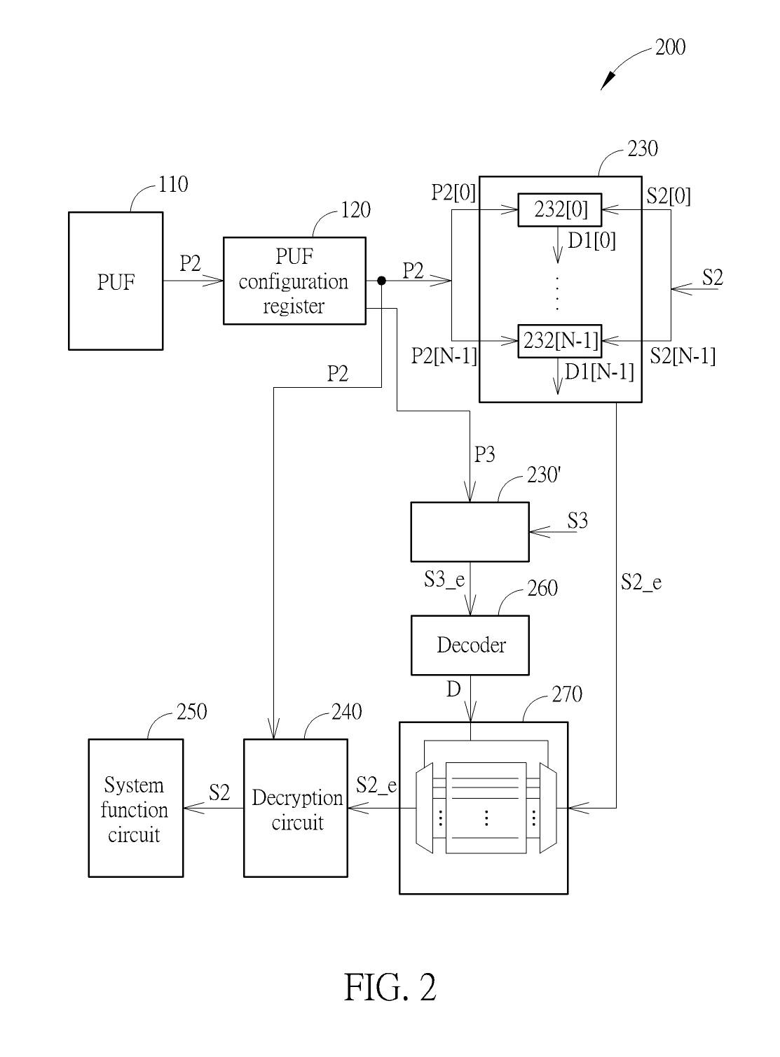

FIG. 2 shows a secure logic system 200 according to another embodiment of the present invention. The secure logic system 200 and the secure logic system 100 have similar structures. However, the encryption circuit 230 can includes a plurality of logic circuits 232[0] to 232[N-1] , where N is a positive integer. Each of the logic circuit 232[0] to 232[N-1] can receive a bit S2[0] to S2[N-1] of the system string S2 and a bit P2[0] to P2[N-1] of the encryption string P2, and can perform a logic computation on the bit S2[0] to S2[N-1] of the system string S2 and the corresponding bit P2[0] to P2[N-1] of the encryption string P2 to generate a bit string of the encrypted data S2_e.

For example, the logic circuit 232[0] can perform logic computation on the bit P2[0] of the encryption string P2 and the bit S2[0] of the system string S2, while the logic circuit 232[N-1] can perform logic computation on the bit P2[N-1] of the encryption string P2 and the bit S2[N-1] of the system string S2.

In some embodiments, since the system string S2 may have to be restored for performing following operations, the logic computation performed by the logic circuits 232[0] to 232[N-1] should be reversible. For example, but not limited to, the plurality of logic circuits 232[0] to 232[N-1] can be XOR gates. That is, the encrypted data S2_e can be generated by performing XOR operations to the encryption string P2 and the system string S2. In this case, the system string can be restored later by performing XOR operations to the encryption string P2 and the encrypted data S2_e easily.

In FIG. 2, the secure logic system 200 further includes a decoder 260 coupled to the PUF configuration register 120 and can receive a unique encryption string P3 from the physically unclonable function 110. The decoder 260 can be an N to 2^{N} decoder (ex. 2 to 4 decoder in the present embodiment), and can decode input signals to output decoded data D. Table 1 shows the truth table of the decoder 260 with the input being two bits of a system string S3. Table 2 shows the truth table of the decoder 260 with the inputs being two bits of the encrypted data S3_e, while the encrypted data S3_e is encrypted and generated by performing bitwise XOR operation on the data string S3 and the encryption string P3. In some embodiments, the encrypted data S3_e can be generated by another encryption circuit 230′.

TABLE 1

| S3[1] | S3[0] | D[3] | D[2] | D[1] | D[0] |
|---|---|---|---|---|---|
| 0 | 0 | 0 | 0 | 0 | 1 |
| 0 | 1 | 0 | 0 | 1 | 0 |
| 1 | 0 | 0 | 1 | 0 | 0 |
| 1 | 1 | 1 | 0 | 0 | 0 |

TABLE 2

| S3 | S3 | P3 | P3 | S3_e | S3_e | D | D | D | D |
|---|---|---|---|---|---|---|---|---|---|
| [1] | [0] | [1] | [0] | [1] | [0] | [3] | [2] | [1] | [0] |
| 0 | 0 | 0 | 0 | 0 | 0 | 0 | 0 | 0 | 1 |
| 0 | 1 | 0 | 0 | 0 | 1 | 0 | 0 | 1 | 0 |
| 1 | 0 | 0 | 0 | 1 | 0 | 0 | 1 | 0 | 0 |
| 1 | 1 | 0 | 0 | 1 | 1 | 1 | 0 | 0 | 0 |
| 0 | 0 | 0 | 1 | 0 | 1 | 0 | 0 | 1 | 0 |
| 0 | 1 | 0 | 1 | 0 | 0 | 0 | 0 | 0 | 1 |
| 1 | 0 | 0 | 1 | 1 | 1 | 1 | 0 | 0 | 0 |
| 1 | 1 | 0 | 1 | 1 | 0 | 0 | 1 | 0 | 0 |
| 0 | 0 | 1 | 0 | 1 | 0 | 0 | 1 | 0 | 0 |
| 0 | 1 | 1 | 0 | 1 | 1 | 1 | 0 | 0 | 0 |
| 1 | 0 | 1 | 0 | 0 | 0 | 0 | 0 | 0 | 1 |
| 1 | 1 | 1 | 0 | 0 | 1 | 0 | 0 | 1 | 0 |
| 0 | 0 | 1 | 1 | 1 | 1 | 1 | 0 | 0 | 0 |
| 0 | 1 | 1 | 1 | 1 | 0 | 0 | 1 | 0 | 0 |
| 1 | 0 | 1 | 1 | 0 | 1 | 0 | 0 | 1 | 0 |
| 1 | 1 | 1 | 1 | 0 | 0 | 0 | 0 | 0 | 1 |

According to Table 2, the same input of the system string S3 as shown in Table 1 would lead to four different results corresponding to the values of the encryption string P3. Consequently, the encryption string P3 can be mixed into general logic functions to create configurable logic structures that alter the device's energy consumption and propagation delay via PUF dictated logic paths, making the reverse engineering much more difficult. This is illustrated in FIG. 2 as the secure logic system 200 includes a path selector 270. In this case, the decoded data D can be used to select a corresponding data path among the data paths provided by the path selector 270.

In FIG. 2, the secure logic system 200 also includes a decryption circuit 240 and a system function circuit 250. The decryption circuit 240 is coupled to the PUF configuration register 120, and can decrypt the encrypted data S2_e to restore the system string S2 according to the encryption string P2 retreated from the physically unclonable function configuration register 120. In this case, the decryption circuit 240 may trace the encrypted data S2_e according to the decoded data D, and perform XOR operation to the encrypted data S2_e and the encryption string P2 to restore the original system string S2.

However, the encryption circuit 230 of the present invention is not limited to perform XOR operation. In some other embodiments, the encryption circuit 230 may perform other logic computation including at least one of the basic operations NAND, AND, NOR, OR, XOR, XNOR and NOT to generate the encrypted data S2_e, and the decryption circuit 240 would reverse the encrypted data S2_e back to the system string S2 with the corresponding computations. In other embodiments, mixed logic operations can be used for the encryption circuit 230 or other logic paths and logic structures to further alter system behavior.

After the system string S2 has been restored, the system function circuit 250 coupled to the decryption circuit 240 would perform operations according to the system string S2. For example, the system function circuit 250 may store the system string S2 to the corresponding storage space if the system string S2 is the data to be written.

In FIG. 2, the secure logic system 200 further includes a path selector 270 disposed between the decryption circuit 240 and the decoder 260. The path selector 270 can select a transmission path from several available paths for the encrypted data S2_e to further complicate the data flow, making it even more difficult to analyze the system behavior. In some embodiments, the path selector 270 may choose the transmission path for the encrypted data S2_e according to the decoded data D.

In other embodiments, the path selector 270 may choose the transmission path according to a random number generated by the system or another unique string provided by the PUF 110.

In this case, the decryption circuit 240 disposed on the signal path between the path selector 270 and the system function circuit 250 can decrypt the encrypted data S2_e to restore the system string S2 right at the system function circuit 250, preventing the restored system string S2 from being retrieved by the side-channel attacks and reverse engineering.

Furthermore, the entangled decode technique is applicable to data paths as well for protection of sensitive information. For example, in some other embodiments, the decoded data D can be used to select a device specific set of data from a memory bank to the system function circuit 250 directly.

However, in some embodiments, if the security condition permits, the encrypted data S2_e may be sent to the decryption circuit 240 for decryption directly before used by the system function circuit 250 without passing through the path selector 270. Also, in some other embodiments, the path selector 270 and the memory bank can be used together to select the device specific set of data for sensitive information storage.

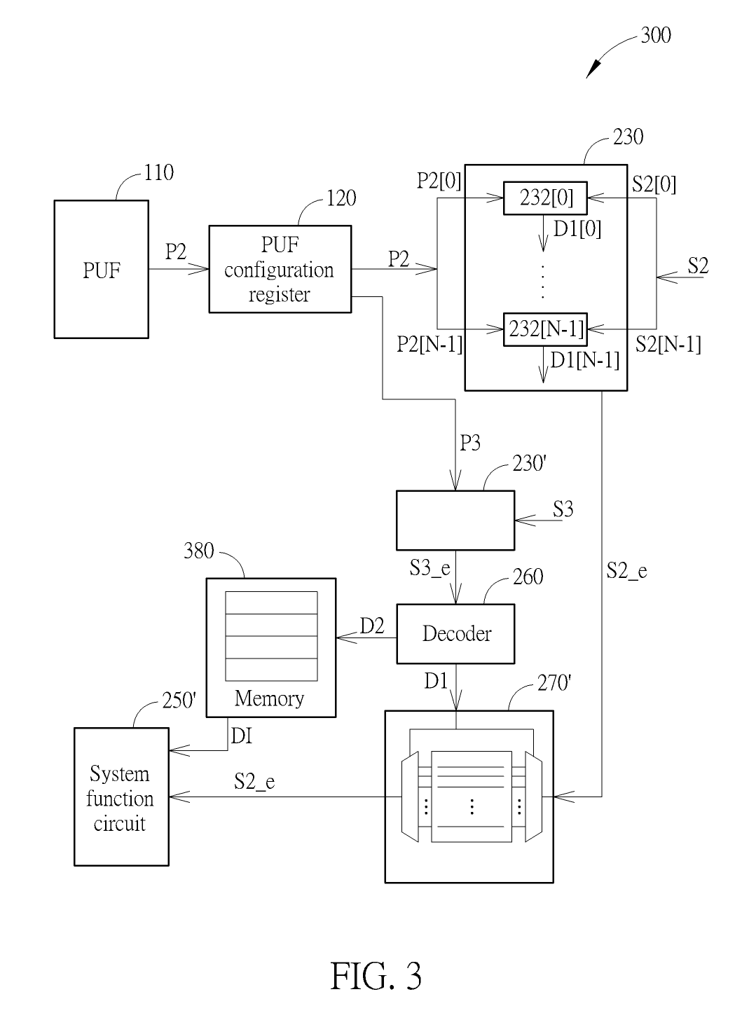

For example, FIG. 3 shows a secure logic system 300 according to another embodiment of the present invention. The secure logic systems 200 and 300 have similar structure. However, in the secure logic system 300, the system function circuit 250′ is a storage device. In this case, the path selector 270′ can be coupled to the system function circuit 250′ as the address bus and the memory 380 can be coupled to the system function circuit 250's for providing the data input DI. In FIG. 3, the decoded data can be divided into part Dl and part D2 for inputting to the path selector 270′ and the memory 380 respectively. However, in some other embodiments, the inputs for the path selector 270′ and the memory 380 can be generated by two different decoders according to the system requirement. In this case, the safety of the data storage can be even improved.

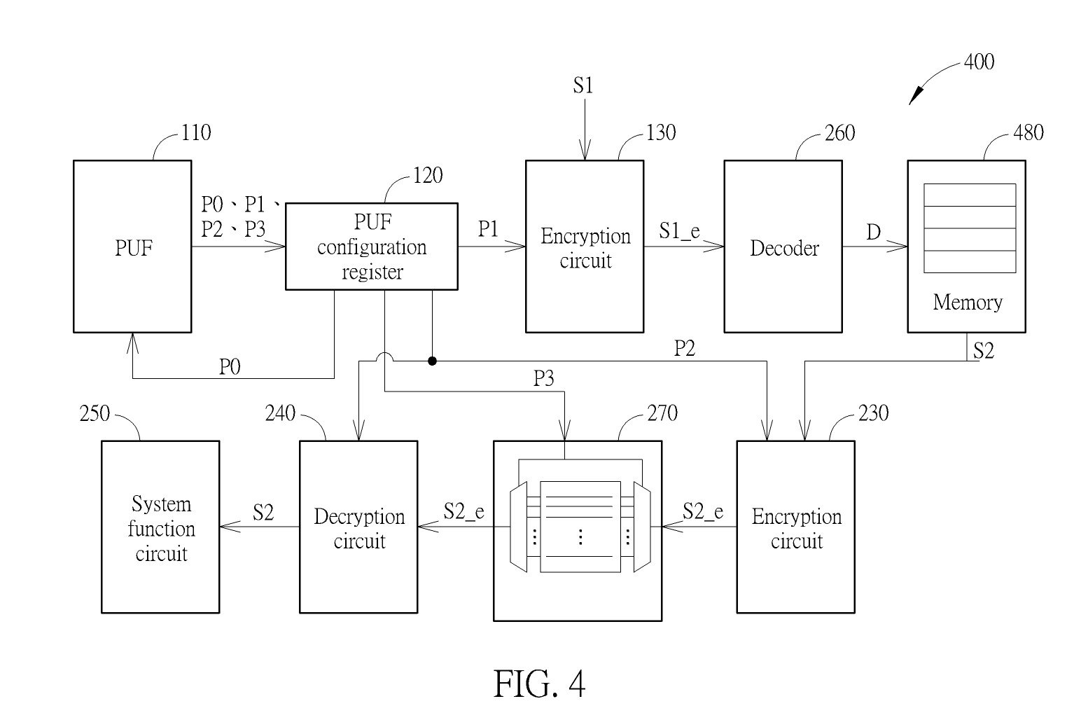

That is, the techniques shown in the embodiments of the present invention can be used independently or can be combined with any desired orders according to the system requirement. FIG. 4 shows a secure logic system 400 according to another embodiment of the present invention. The secure logic system 400 includes the PUF 110, the PUF configuration register 120, the encryption circuits 130 and 230, the memory 480, the path selector 270, the decryption circuit 240, and the system function circuit 250.

In FIG. 4, the encryption circuit 130 can manipulate the system string S1 to generate the encrypted data S1_e, and the decoder 260 can further decode the encrypted data S1_e to generate the decoded data D as the address for memory 480 to retrieve the system string S2. The system string S2 can be encrypted to generate the encrypted data S2_e by the encryption circuit 230. That is, the encryption methods used by the secure logic systems 100 and 200 are combined in the secure logic system 400 to provide a thorough protection along the data path. Nevertheless, in FIG. 4, the path selector 270 may provide several data paths and the encrypted data S2_e can be transmitted through one of the data paths according to the encryption string P3. Consequently, the data path selection can be further randomized, making it even more difficult to analyze the system behavior. After the encrypted data S2_e is transmitted through the selected data path, the encrypted data S2_e can be finally decrypted by the decryption circuit 240 according to the encryption string P2, and will be used for the following operation in the system function circuit 250.

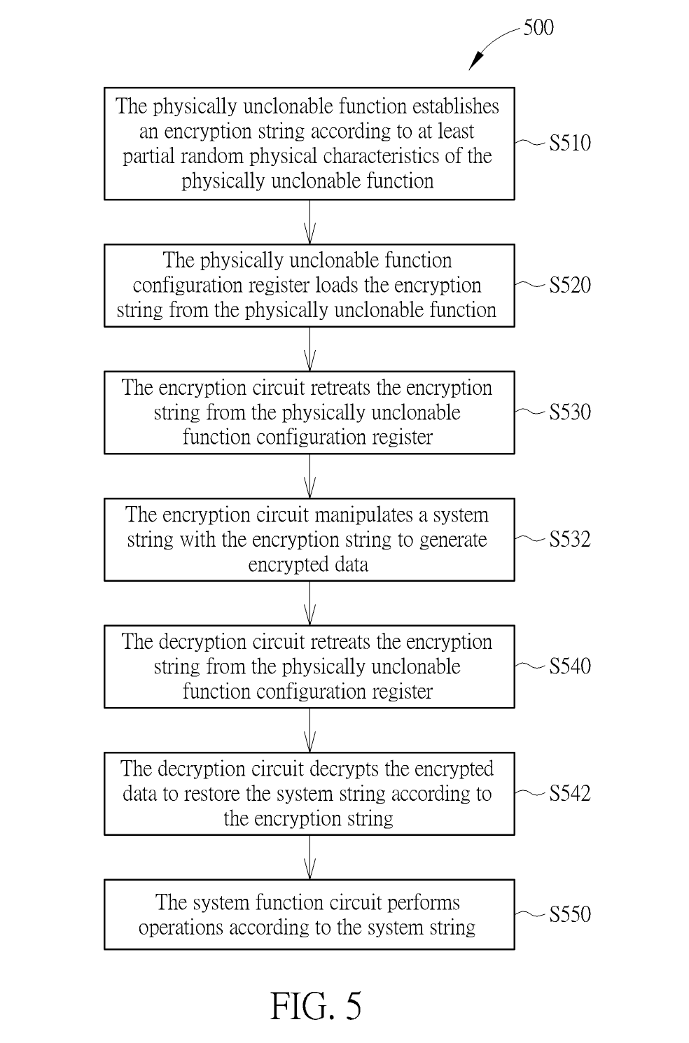

FIG. 5 shows a flow chart of a method 500 for operating the secure logic system 100. The method 500 includes steps 5510 to 5550.

S510: the physically unclonable function 110 establishes an encryption string P1 according to at least partial random physical characteristics of the physically unclonable function 110;

S520: the physically unclonable function configuration register 120 loads the encryption string P1 from the physically unclonable function 110;

S530: the encryption circuit 130 retreats the encryption string P1 from the physically unclonable function configuration register 120;

S532: the encryption circuit 130 manipulates a system string S1 with the encryption string P1 to generate encrypted data S1_e;

S540: the decryption circuit 140 retreats the encryption string P1 from the physically unclonable function configuration register 120;

S542: the decryption circuit 140 decrypts the encrypted data S1_e to restore the system string S1 according to the encryption string Pl;

S550: the system function circuit 150 performs operations according to the system string Sl.

According to method 500, the system string S1 can be mixed with the unique encryption string P1, making the physical behaviors of identical operation with identical data dramatically different from one another. In some embodiments, the system string S1 can be a memory address, memory data, or an instruction, and the method 500 may be applied to encrypt different types of system strings with different algorithms or different Boolean operations to further complicate the flow controls and data paths for critical functions, making side-channel attacks and reverse engineering much more difficult.

In some embodiments, the encryption circuit 130 may perform the Excess-N binary coding scheme to manipulate the system string S1 by using the encryption string P1 as a seed to select at least one inverting bit of the system string S1 in step S532. However, in some other embodiments, the encryption circuit 130 may adopt other algorithms or other logic computation to manipulate the system string S1. For example, the encryption circuit 130 may perform XOR operations to the system string S1 and the encryption string P1 to generate the encrypted data S1_e.

After the system string S1 has been mixed with the encryption string P1, the decryption circuit 140 can retreat the encryption string P1 in step S540 to restore the system string S1 in step S542, so that the system function circuit 150 can use the system string S1 for following operations accordingly in step S550.

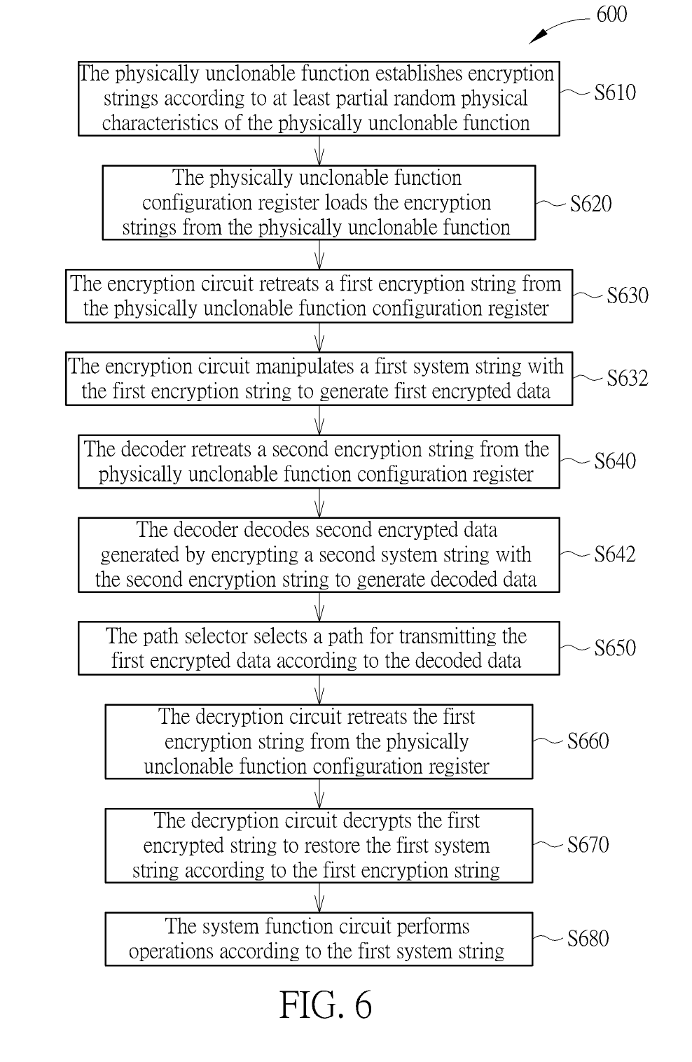

In some embodiments, additional protections for encrypted data S1_e may be achievable by further alter the device's energy consumption and propagation delay via unpredictable logical paths. FIG. 6 shows a flow chart of a method 600 for operating the secure logic system 200. The method 600 includes steps S610 to S680.

S610: the physically unclonable function 110 establishes encryption strings P2 and P3 according to at least partial random physical characteristics of the physically unclonable function 110;

S620: the physically unclonable function configuration register 120 loads the encryption strings P2 and P3 from the physically unclonable function 110;

S630: the encryption circuit 230 retreats encryption string P2 from the physically unclonable function configuration register 120;

S632: the encryption circuit 230 manipulates a system string S2 with the encryption string P2 to generate encrypted data S2_e;

S640: the decoder 260 retreats encryption string P3 from the physically unclonable function configuration register 120;

S642: the decoder 260 decodes another encrypted data S3_e generated by encrypting another system string S3 with the encryption string P3 to generate decoded data D;

S650: the path selector 270 selects a path for transmitting the encrypted data S2_e according to the decoded data D;

S660: the decryption circuit 240 retreats the encryption string P2 from the physically unclonable function configuration register 120;

S670: the decryption circuit 240 decrypts the encrypted string S2_e to restore the system string S2 according to the encryption string P2;

S680: the system function circuit 250 performs operations according to the system string S2.

That is, after the system string S2 is encrypted with the encryption string P2, the encrypted data S2_e is transmitted through the data path selected by the path selector 270 to the decryption circuit 240 in step S650 according to the decoded data D. Therefore, in step S670, the decryption circuit 240 can decrypt the encrypted string S2_e to restore the system string S2, so that the system function circuit 250 can perform the following operations accordingly in step S680.

In some embodiments, if the system string S2 is an instruction or an arbitrary indicator, then the decryption circuit 240 may not have to regenerate the complete system string S2. Instead, the decryption circuit 240 may transmit the corresponding signals to the system function circuit 250 for performing the respective operation by analyzing the encrypted data S2_e with the encryption string P2.

With both the methods 500 and 600, the encryption string established by the physical unclonable function 110 can be used to combine with the system string so that the control paths and the data flow patterns would be unique to each individual device. Also, since the valuable information required by the side-channel attacks and reverse engineering, such as device timing, energy, heat, magnetic profiles, and power signatures, would also be changed accordingly due to physical changes of logic structure, flow control and data presentation, the methods 500 and 600 can secure the information effectively. Moreover, when applying the methods 500 and 600 to different types of system strings, the protection for the valuable information can be further enhanced. That is, the approaches shown in methods 500 and 600 maybe performed individually or may be combined with others to meet the security requirement of the system.

In summary, the secure logic systems and the method for operating the secure logic systems provided by the embodiments of the present invention can combine the system string with the unpredictable encryption string established by PUF, so that the control paths and the data flow patterns would be unique to each individual device. Also, since each individual device can have its own device timing, energy, heat, magnetic profiles, and power signatures, the critical information can be secured effectively, making the side-channel attacks and reverse engineering extremely difficult.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A secure logic system, comprising:
a physically unclonable function (PUF) configured to establish an encryption string according to at least partial random physical characteristics of the physically unclonable function;
a physically unclonable function configuration register coupled to the physically unclonable function, and configured to load the encryption string from the physically unclonable function; and
an encryption circuit coupled to the physically unclonable function configuration register, and configured to manipulate a system string with the encryption string to generate encrypted data.

2. The secure logic system of claim 1, wherein the system string is a memory address, memory data, or an instruction.

3. The secure logic system of claim 1, wherein:
the encryption circuit performs an Excess-N binary coding scheme to manipulate the system string by using the encryption string as a seed to select at least one inverting bit of the system string.

4. The secure logic system of claim 1, wherein:
the encryption circuit includes a plurality of logic circuits, each configured to receive a bit of the system string and a bit of the encryption string and perform a logic computation on the bit of the system string and the bit of the encryption string to generate a bit of the encrypted data.

5. The secure logic system of claim 4, wherein:
the plurality of logic circuits are XOR gates.

6. The secure logic system of claim 1, further comprising a decoder coupled to the encryption circuit, and configured to decode the encrypted data to output decoded data for randomizing a transmission path of the encrypted data.

7. The secure logic system of claim 6, further comprising:
a decryption circuit coupled to the physically unclonable function configuration register, and configured to decrypt the decoded data to restore the system string according to the encryption string retreated from the physically unclonable function configuration register; and
a system function circuit coupled to the decryption circuit, and configured to perform operations according to the system string.

8. The secure logic system of claim 7, wherein the decryption circuit is disposed on a signal path between the decoder and the system function circuit, and decrypts the decoded data to restore the system string right before sending the system string to the system function circuit.

9. The secure logic system of claim 1, further comprising:
a decryption circuit coupled to the physically unclonable function configuration register, and configured to decrypt the encrypted data to restore the system string according to the encryption string retreated from the physically unclonable function configuration register; and
a system function circuit coupled to the decryption circuit, and configured to perform operations according to the system string.

10. The secure logic system of claim 9, wherein the decryption circuit is disposed on a signal path between the encryption circuit and the system function circuit, and decrypts the encrypted data to restore the system string right before sending the system string to the system function circuit.

11. The secure logic system of claim 1, wherein an address for loading the encryption string in the physically unclonable function is created by entangling another encryption string to a default address.

12. The secure logic system of claim 1, wherein an initial system condition used to generate the encryption string is stored in a safe environment or an one-time programming circuit.

13. The secure logic system of claim 1, wherein the encrypted data is used as a physical address to access a memory.

14. The secure logic system of claim 1, wherein the encrypted data is used to create configurable logic structures by entangling with generic logic.

15. The secure logic system of claim 1, further comprising a path selector configured to receive the encrypted data and select a data path for the encrypted data according to a string provided by the PUF to randomize transmission paths of the encrypted data.

16. A method for operating a secure logic system, the secure logic system comprising a physically unclonable function (PUF), a physically unclonable function configuration register, and an encryption circuit, and the method comprising:
the physically unclonable function (PUF) establishing an encryption string according to at least partial random physical characteristics of the physically unclonable function;
the physically unclonable function configuration register loading the encryption string from the physically unclonable function; and
the encryption circuit manipulating a system string with the encryption string to generate encrypted data.

17. The method of claim 16, wherein the system string is a memory address, a memory data, or an instruction.

18. The method of claim 16, wherein:
the encryption circuit manipulating the system string with the encryption string to generate the encrypted data is the encryption circuit performing an Excess-N binary coding scheme to manipulate the system string by using the encryption string as a seed to select at least one inverting bit of the system string.

19. The method of claim 16, wherein:
the encryption circuit manipulating the system string with the encryption string to generate the encrypted data comprises:
the encryption circuit receiving a bit of the system string and a bit of the encryption string; and
the encryption circuit performing a logic computation on the bit of the system string and the bit of the encryption string to generate a bit of the encrypted data.

20. The method of claim 19, wherein:
the logic computation includes XOR operation.

21. The method of claim 16, wherein the secure logic system further comprises a decoder, and the method further comprises the decoder decoding the encrypted data to randomize a transmission path of the encrypted data.

22. The method of claim 21, wherein the secure logic system further comprises a decryption circuit and a system function circuit, and the method further comprises:
the decryption circuit retreats the encryption string from the physically unclonable function configuration register;
the decryption circuit decrypting the decoded data to restore the system string according to the encryption string; and
the system function circuit performing operations according to the system string.

23. The method of claim 22, wherein the decryption circuit is disposed on a signal path between the decoder and the system function circuit, and the decryption circuit decrypting the decoded data to restore the system string according to the encryption string is performed right before sending the system string to the system function circuit.

24. The method of claim 16, wherein the secure logic system further comprises a decryption circuit and a system function circuit, and the method further comprises:
the decryption circuit retreating the encryption string from the physically unclonable function configuration register;
the decryption circuit decrypting the encrypted data to restore the system string according to the encryption string; and
the system function circuit performing operations according to the system string.

25. The method of claim 24, wherein the decryption circuit is disposed on a signal path between the encryption circuit and the system function circuit, and the decryption circuit decrypting the encrypted data to restore the system string according to the encryption string is performed right before sending the system string to the system function circuit.

26. The method of claim 16, further comprising creating an address for loading the encryption string in the physically unclonable function by entangling another encryption string to a default address.

27. The method of claim 16, further comprising storing an initial system condition used to generate the encryption string in a safe environment or an one-time programming circuit.

28. The method of claim 16, further comprising accessing a memory by using the encrypted data as a physical address.

29. The method of claim. 16, further comprising creating configurable logic structures by entangling generic logic with the encrypted data.

30. The method of claim 16, wherein the secure system further comprises a path selector, and the method further comprises the path selector selecting a data path for the encrypted data according to a string provided by the PUF to randomize transmission paths of the encrypted data.
